(19) United States
(12) Patent Application Publication
(10) Pub. No.: US 2013/0317387 A1
(43) Pub. Date: Nov. 28, 2013

(54) METHODS FOR DIAGNOSING COGNITIVE IMPAIRMENT

(71) Applicant: Nestec SA, Vevey (CH)

(72) Inventor: Brian Michael Zanghi, Ballwin, MO (US)

(73) Assignee: Nestec SA, Vevey (CH)

(21) Appl. No.: 13/899,894

(22) Filed: May 22, 2013

Related U.S. Application Data
(60) Provisional application No. 61/651,182, filed on May 24, 2012.

(51) Int. Cl. A61D 99/00

(52) U.S. Cl. CPC A61D 99/00
USPC 600/549

(57) ABSTRACT

The invention provides methods for diagnosing cognitive impairment in a canine. The methods comprise measuring a first body temperature of the canine from about 0.5 to about 3 hours after waking; measuring a second body temperature of the canine from about 8 to about 13 hours after measuring the first body temperature; and determining that the canine is cognitively impaired if the first body temperature is less than 0.6° C. lower than the second body temperature.

### CROSS REFERENCE TO RELATED APPLICATIONS

This application claims priority to U.S. Provisional Application Ser. No. 61/651182 filed May 24, 2012, the disclosure of which is incorporated herein by this reference.

### BACKGROUND OF THE INVENTION

1. Field of the Invention

The invention relates generally to methods for diagnosing cognitive impairment in canines and particularly to methods for diagnosing cognitive impairment in canines by measuring body temperature.

2. Description of Related Art

Aged or aging canines frequently suffer some degree of cognitive impairment. Canine Cognitive Dysfunction Syndrome (CCDS) is the age related deterioration of cognitive abilities. Canines with CCDS exhibit various behavioral disorders. For example, they may not respond to their name or familiar commands, may get lost or confused even in familiar surroundings, may no longer greet or respond to their owners or visitors, may exhibit diminished daytime activity, may walk in circles, may shun affection, and may lose bladder or bowel control. Early detection of cognitive impairment will help healthcare professionals and pet owners make informed choices about reducing the risk of developing CDS in their canines. Nutritional supplementation has a potentially valuable role to play in maximizing the benefit of therapy in terms of increasing the canines' quality of life. Key to this benefit is the early detection of cognitive impairment thereby enabling canines to receive the most appropriate care.

Body temperatures cycle up and down throughout the day as part of the circadian rhythm. Canines with cognitive impairment typically experience an alteration in their circadian rhythms.

There remains a need for diagnosing cognitive impairment in canines to provide the most appropriate and effective level of treatment. The use of body temperature as an indicator of cognitive impairment provides a simple and convenient method for veterinary clinicians and pet-owners. Such treatment will improve the canine's quality of life. The present invention satisfies this need.

### SUMMARY OF THE INVENTION

It is, therefore, an object of the present invention to provide methods for diagnosing cognitive impairment in canines.

This and other objects are achieved using methods for diagnosing cognitive impairment in a canine that involve measuring a first body temperature of the canine, from about 0.5 to about 3 hours after waking; measuring a second body temperature of the canine front about 8 to about 13 hours after measuring the first body temperature; and determining that the canine is cognitively impaired if the first body temperature is less than 0.6° C. lower than the second body temperature.

Other and further objects, features, and advantages of the present invention will be readily apparent to those skilled in the art.

### DETAILED DESCRIPTION OF THE INVENTION

### Definitions

The term “canine” means any canine susceptible to or suffering from, cognitive impairment.

The term “dog” means all domesticated canines, including working dogs and pet dogs.

The term “senior” means a canine of an age having an increased risk for age-related disease, e.g., cognitive impairment, but may or may not have obvious physical or behavioral characteristics of aging. For example, for dogs, “senior” means an age of from about 7 years to about 11 years, or older.

The term “comparable control canine” means a canine of the same species and type or an individual canine evaluated at two different times.

The term “diagnosing” means determining if a canine is suffering from or predicting if the canine is likely to developing cognitive impairment.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a method” includes a plurality of such “methods,” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The methods and compositions and other advances disclosed here are net limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides methods for diagnosing cognitive impairment in a canine. The methods comprise measuring a first body temperature of the canine from about 0.5 to about 3 hours after waking; measuring a second body temperature of the canine from about 8 to about 13 hours after measuring the first body temperature; and determining that the canine is cognitively impaired if the first body temperature is less than 0.6° C. lower than the second body temperature.

In one embodiment, both the first temperature and the second temperature are less than 38° C.

In various embodiments, the first body temperature of the canine is measured from 0.5 to about 3 hours after waking; preferably from about 1 to about 2.5 hours after waking; more preferably from about 1 to about 2 hours after waking.

In various embodiments, the second body temperature is measured at about 8 to about 13 hours after measuring the first body temperature, preferably from about 9 to about 12 hours after measuring the first body temperature, more preferably from about 9 to about 11 hours after measuring the first body temperature.

In another aspect, the invention provides methods for diagnosing cognitive impairment in a canine. The methods comprising measuring a first body temperature of the canine at about 6 am to about 11 am; measuring a second body temperature of the canine at about 4 pm to about 11 pm; and determining that the canine is cognitively impaired if the first body temperature is less than 0.6°° C. lower than the second body temperature.

In one embodiment both the first temperature and the second temperature are less than 38° C.

In various embodiments, the first body temperature of the canine is measured at about 6 am to about 11 am. preferably at about 7 am to 10 am, more preferably at about 8 am to 10 am.

In another embodiment, the second body temperature is measured at about 4 pm to about 11 pm, preferably at about 5 pm to about 11 pm, more preferably at about 6 pm to about 8 pm. In one embodiment, the second body temperature is measured at about 7 pm,

In various embodiments, the canine is a dog. In one embodiment the dog is a senior dog. In another embodiment, the senior dog is 9 or more years of age.

The inventions are based upon the discovery that body temperature in cognitively impaired canines is lower compared to body temperature in comparable control canines that are not cognitively impaired. In addition, it was discovered that the range of daily body temperature in cognitively impaired canines is lower compared to comparable control canines that are not cognitively impaired. The invention allows veterinary and other clinicians to use body temperature to determine whether the canine is likely to develop cognitive impairment or is suffering from cognitive impairment and whether there is a need for further diagnostics or treatments. Having established the need for further diagnostics or treatments using the simple method for the invention, the cost and risk of such further more expensive or invasive diagnostics or treatments are justified.

### EXAMPLES

The invention can be further illustrated by the following examples, although it will be understood that these examples are included merely for purposes of illustration and are not intended to limit the scope of the invention unless otherwise specifically indicated.

### Example 1

Sixty (60) dogs were selected from a pool of seventy dogs, which were at least eight years of age. The selection was based on memory performance using a variable delay non-matching to position task (varDNMP). First, the dogs were placed in three non-overlapping groups that were defined as:
Group A: High Performing Memory (HPM), N=12
Group B: Low Performing Memory (LPM), N=24
Group C: Moderate Performing Memory (MPM), N=24

DNMP testing was carried out at baseline and again after 45 days. Dogs were tested on three-choice varNMP for 10 baseline days, and for 14 days during retest. All DNMF resting will consist of variable-delayed testing in which delays of 20 and 90 seconds will occur with equal frequency over the 12 test trials per day, resulting in 60 trials for each delay during baseline and 84 trials for each delay during retest. The delays will occur randomly within the test sessions, with the constraint that each delay will occur on exactly 6 trials.

Core body temperature was measured based on rectal temperature collected during the baseline phase and end-of-study phase. Core body temperature readings were recorded at 8 AM (±30 mins), 10 AM (±30 mins), 1 PM (±30 mins), 3 PM (±30mins), 7PM (±30mins), and 1:30 AM (±15 mins).

To establish whether the varDNMP baseline groupings had different core body temperatures, the control canines from each of the three groups were compared during the baseline portion of the study. As detailed in Table 1, the LPM canines had mean core (rectal) body temperature readings that were quantitatively lower at all 6 time points recorded within a 24 hour period -compared to the HPM and MPM canines. Of particular importance was the 7 pm recording, which demonstrated the peak body temperature. LPM dogs had a 0.44° C. lower body temperature at this peak time compared to HPM and MPM canines. Referring to Table 1, the data shows that body temperature can be used to diagnose cognitive impairment in canines.

TABLE 1
Body Temperature Data of Control Dogs (N = 36) Recorded
at Multiple Times During the Day of the Baseline Phase

| | 8:00 | 10:00 | 1:00 | 3:00 | 7:00 | 1:30 |
|---|---|---|---|---|---|---|
| | AM | AM | PM | PM | PM | AM |
| HPM Dogs | 37.46 | 37.38 | 37.77 | 37.73 | 38.26 | 37.83 |
| MPM Dogs | 37.41 | 37.48 | 37.76 | 37.74 | 38.24 | 37.75 |
| LPM Dogs | 37.24 | 37.28 | 37.55 | 37.33 | 37.82 | 37.61 |

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

What is claimed is:

1. A method for diagnosing cognitive impairment in a canine comprising
a. measuring a first body temperature of the canine from about 0.5 to about 3 hours after waking:
b. measuring a second body temperature of the canine from about 8 to about 13 hours after measuring the first body temperature; and
c. determining that the canine is cognitively impaired if the first body temperature is less than 0.6° C. lower than the second body temperature.

2. The method of claim 1 wherein the first body temperature of the canine is measured from about 1 to about 2.5 hours after waking,

3. The method of claim 1 wherein the first body temperature of the canine is measured from about 1 to about 2 hours after waking.

4. The method of claim 1 wherein the second body temperature of the canine is measured from about 9 to about 12 hours after measuring the first body temperature.

5. The method of claim I wherein the second body temperature of the canine is measured from about 9 to about 11 hours after measuring the first body temperature,

6. The method of claim 1 wherein the canine is a dog.

7. The method of claim 6 wherein the dog is a senior dog.

8. The method of claim 7 wherein the senior dog is 9 or more years of age.

9. The method of claim 1 wherein both the first temperature and the second temperature are less than 38° C.

10. A method for diagnosing cognitive impairment in a canine comprising
a. measuring a first body temperature of the canine at about 6 am to about 11 am;
b. measuring a second body temperature of the canine at about 4 pm to about 11 pm; and
c. determining that the canine is cognitively impaired if the first body temperature is less than 0.6° C. lower than the second body temperature

11. The method of claim 10 wherein the first body temperature of the canine is measured at about 7 am to about 10 am.

12. The method of claim 10 wherein the first body temperature of the canine is measured at about 8 am to about 10 am.

13. The method of claim 10 wherein the second body temperature of the canine is measured at about 5 pm to about 11 pm.

14. The method of claim 10 wherein the second body temperature of the canine is measured at about 6 pm to about 8 pm.

15. The method of claim 10 wherein the second body temperature of the canine is measured at about 7 pm.

16. The method of claim 10 wherein the canine is a dog.

17. The method of claim 16 wherein the dog is a senior dog.

18. The method of claim 17 wherein the senior dog is 9 or more years of age.

19. The method of claim 10 wherein both the first temperature and the second temperature are less than 38° C.
